(19) United States
(12) Patent Application Publication
(10) Pub. No.: US 2013/0050609 A1
(43) Pub. Date: Feb. 28, 2013

(54) DISPLAY DEVICE, BARRIER DEVICE, RETARDATION FILM AND ELECTRONIC APPARATUS

(71) Applicant: Yuichi Inoue, Kanagawa (JP)

(72) Inventor: Yuichi Inoue, Kanagawa (JP)

(73) Assignee: SONY CORPORATION, Tokyo (JP)

(21) Appl. No.: 13/572,268

(22) Filed: Aug. 10, 2012

(30) Foreign Application Priority Data
Aug. 26, 2011 (JP) 2011-184804

(51) Int. Cl. G02F 1/13357

(52) U.S. Cl. 349/61; 349/101; 349/117

(57) ABSTRACT

Disclosed herein is a display device including: a liquid crystal layer; a first substrate configured to include a first polarization film and a first retardation film; and a second substrate configured to include a second polarization film and be disposed on a side on which the first retardation film, of the first polarization film and the first retardation film, is disposed, of the first substrate, with intermediary of the liquid crystal layer, wherein an in-plane retardation value R0 of in-plane direction of the first retardation film and a thickness retardation value Rth of thickness direction of the first retardation film satisfy expression (A):

R0≦(⅝)×Rth−25 (A).

### CROSS REFERENCES TO RELATED APPLICATIONS

The present application claims priority to Japanese Priority Patent Application JP 2011-184804 filed in the Japan Patent Office on Aug. 26, 2011, the entire content of which is hereby incorporated by reference.

### BACKGROUND

The present disclosure relates to a display device and a barrier device configured by a liquid crystal element, a retardation film used for such devices, and an electronic apparatus including them.

In recent years, in the display device, replacement of the cathode ray tube (CRT) display device by the liquid crystal display device is being progressed. The liquid crystal display device can be made smaller in thickness than the CRT display device and thus readily realizes space-saving. In addition, it has low power consumption and therefore is advantageous also from an ecological viewpoint.

Furthermore, in recent years, a display device that can realize stereoscopic displaying is attracting attention. In the stereoscopic displaying, a left-eye image and a right-eye image having parallax from each other (having different viewpoints) are displayed and the viewer sees the images by the left and right eyes, respectively, and thereby can recognize the images as a stereoscopic image with depth. Furthermore, there has also been developed a display device that displays three or more images having parallax from each other and thereby can offer the viewer a more natural stereoscopic image. For example, Japanese Patent Laid-open No. Hei 3-119889 discloses a display device of a parallax barrier system. This display device simultaneously displays plural images (viewpoint images) having parallax from one another, and the image seen by the viewer differs depending on the relative positional relationship (angle) between the display device and the viewpoint of the viewer. In such a display device, a liquid crystal element is often used as the barrier.

In general, the display device is desired to have a wide viewing angle. Japanese Patent Laid-open Nos. 2005-189888 and 2001-100031 disclose liquid crystal display devices having a layer composed of a discotic liquid crystal having optical anisotropy in order to widen the viewing angle. Such a layer composed of a discotic liquid crystal is distributed as a viewing angle enhancement film (e.g. so-called WV (Wide View) film).

### SUMMARY

In general, an electronic apparatus is desired to achieve cost reduction. However, in the display device having the liquid crystal element, the above-described viewing angle enhancement film is a dedicated member and therefore introduction thereof possibly takes a high cost.

The present disclosure has been devised in view of the above situation, and provided a display device, a barrier device, a retardation film, and an electronic apparatus that each allow viewing angle widening and cost reduction.

According to an embodiment of the present disclosure, there is provided a first display device including a liquid crystal layer, a first substrate, and a second substrate. The first substrate includes a first polarization film and a first retardation film. The second substrate includes a second polarization film and is disposed on a side on which the first retardation film, of the first polarization film and the first retardation film, is disposed, of the first substrate, with the intermediary of the liquid crystal layer. An in-plane retardation value R0 of the in-plane direction of the first retardation film and a thickness retardation value Rth of the thickness direction of the first retardation film satisfy expression (A).

R0≦(⅝)×Rth−25 (A)

According to another embodiment of the present disclosure, there is provided a second display device including a display section and a barrier section. The barrier section has a liquid crystal barrier capable of being switched between an opened state and a closed state. The barrier section includes a liquid crystal layer, a first substrate including a polarization film and a retardation film, and a second substrate disposed on a side on which the retardation film, of the polarization film and the retardation film, is disposed, of the first substrate, with the intermediary of the liquid crystal layer. An in-plane retardation value R0 of the in-plane direction of the retardation film and a thickness retardation value Rth of the thickness direction of the retardation film satisfy expression (A).

R0≦(⅝)×Rth−25 (A)

According to further embodiment of the present disclosure, there is provided a barrier device including a barrier section having a liquid crystal barrier capable of being switched between an opened state and a closed state. The barrier section includes a liquid crystal layer, a first substrate including a polarization film and a retardation film, and a second substrate disposed on a side on which the retardation film, of the polarization film and the retardation film, is disposed, of the first substrate, with the intermediary of the liquid crystal layer. An in-plane retardation value R0 of the in-plane direction of the retardation film and a thickness retardation value Rth of the thickness direction of the retardation film satisfy expression (A).

R0≦(⅝)×Rth−25 (A)

According to still further embodiment of the present disclosure, there is provided a retardation film in which an in-plane retardation value R0 of the in-plane direction and a thickness retardation value Rth of the thickness direction satisfy expression (A).

R0≦(5/8)×Rth−25 (A)

According to even further embodiment of the present disclosure, there is provided an electronic apparatus including the above-described first display device. Examples of the electronic apparatus include television devices, digital cameras, personal computers, video camcorders, and portable terminal devices such as cellular phones.

In the first display device, the retardation film, and the electronic apparatus of the embodiments of the present disclosure, light is modulated in the liquid crystal layer and an image is displayed on the display screen. In the first retardation film, through which the light is transmitted in this displaying, the in-plane retardation value R0 and the thickness retardation value Rth satisfy expression (A).

In the second display device, the barrier device, and the retardation film of the embodiments of the present disclosure, an image is displayed on the display section and the image displayed on the display section is visually recognized by the viewer by setting the liquid crystal barrier to the transmissive state. In the retardation film of the barrier section, through which light is transmitted at this time, the in-plane retardation value R0 and the thickness retardation value Rth satisfy expression (A).

According to the first and second display devices, the barrier device, the retardation film, and the electronic apparatus of the embodiments of the present disclosure, the retardation film in which the in-plane retardation value R0 and the thickness retardation value Rth satisfy expression (A) is used. Thus, the viewing angle can be widened and the cost can be reduced.

Additional features and advantages are described herein, and will be apparent from the following Detailed Description and the figures.

### BRIEF DESCRIPTION OF THE FIGURES

FIG. 1 is a block diagram showing one configuration example of a display device according to a first embodiment of the present disclosure;

FIG. 2 is a block diagram showing one configuration example of a display drive section shown in FIG. 1;

FIG. 3 is a circuit diagram showing one configuration example of a pixel shown in FIG. 2;

FIG. 4 is a sectional view showing one configuration example of a liquid crystal display section shown in FIG. 1;

FIG. 5 is a sectional view showing one configuration example of a polarization film shown in FIG. 4;

FIGS. 6A and 6B are schematic diagrams showing one operation example of a liquid crystal layer shown in FIG. 4;

FIG. 7 is an explanatory diagram for explaining the function of a retardation film shown in FIG. 4;

FIG. 8 is a characteristic diagram showing one characteristic example of the display device shown in FIG. 1;

FIG. 9 is a characteristic diagram showing another characteristic example of the display device shown in FIG. 1;

FIG. 10 is a block diagram showing one configuration example of a stereoscopic display device according to a second embodiment;

FIGS. 11A and 11B are explanatory diagrams showing one configuration example of the stereoscopic display device shown in FIG. 10;

FIGS. 12A and 12B are a plan view and a sectional view showing one configuration example of a liquid crystal barrier section shown in FIG. 10;

FIG. 13 is an explanatory diagram showing a group configuration example of the liquid crystal barrier section shown in FIG. 10;

FIGS. 14A, 14B and 14C are schematic diagrams showing one operation example of the stereoscopic display device shown in FIG. 10;

FIGS. 15A and 15B are another schematic diagrams showing one operation example of the stereoscopic display device shown in FIG. 10;

FIGS. 16A and 16B are explanatory diagrams showing one configuration example of a stereoscopic display device according to a modification example;

FIGS. 17A and 17B are schematic diagrams showing one operation example of the stereoscopic display device according to the modification example;

FIGS. 18A, 18B and 18C are schematic diagrams showing one operation example of a stereoscopic display device according to another modification example; and

FIG. 19 is a perspective view showing the appearance configuration of a television device to which the display device and the stereoscopic display device according to the embodiments are applied.

### DETAILED DESCRIPTION

Embodiments of the present disclosure will be described in detail below with reference to the drawings. The order of the description is as follows.
1. First Embodiment (display device)
2. Second Embodiment (stereoscopic display device)
3. Application Examples

### 1. First Embodiment

### Configuration Example

(Overall Configuration Example)

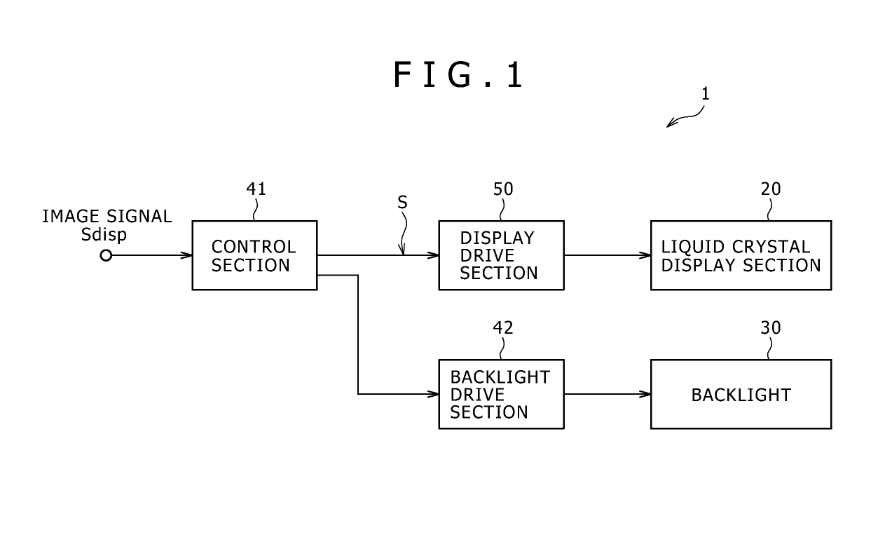

FIG. 1 shows one configuration example of a display device according to a first embodiment. A display device 1 is a liquid crystal display device using a liquid crystal element as a display element. A retardation film according to an embodiment of the present disclosure is embodied by the present embodiment and therefore will be described together.

The display device 1 includes a control section 41, a backlight drive section 42, a backlight 30, a display drive section 50, and a liquid crystal display section 20.

The control section 41 is a circuit that supplies a control signal to each of the backlight drive section 42 and the display drive section 50 based on an image signal Sdisp supplied from the external. Specifically, the control section 41 supplies a backlight control signal to the backlight drive section 42 and supplies an image signal S based on the image signal Sdisp to the display drive section 50.

The backlight drive section 42 drives the backlight 30 based on the backlight control signal supplied from the control section 41. The backlight 30 has a function to output surface-emitted light to the liquid crystal display section 20. The backlight 30 is configured by using e.g. a light emitting diode (LED) or a cold cathode fluorescent lamp (CCFL).

The display drive section 50 drives the liquid crystal display section 20 based on the image signal S supplied from the control section 41. The liquid crystal display section 20 drives the liquid crystal element and modulates the light emitted from the backlight 30 to thereby perform displaying.

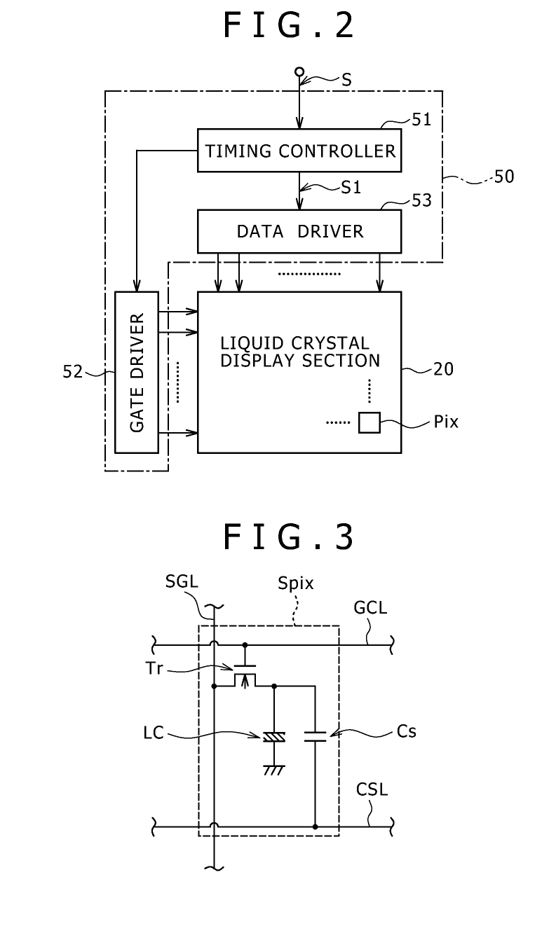

FIG. 2 shows one example of a block diagram of the display drive section 50. The display drive section 50 includes a timing controller 51, a gate driver 52, and a data driver 53. The timing controller 51 controls the drive timing of the gate driver 52 and the data driver 53. In addition, it generates an image signal S1 based on the image signal S supplied from the control section 41 and supplies it to the data driver 53. The gate driver 52 sequentially selects pixels Pix in the liquid crystal display section 20 on a row-by-row basis to perform line-sequentially scanning in accordance with the timing control by the timing controller 51. The data driver 53 supplies a pixel signal based on the image signal S1 to each pixel Pix of the liquid crystal display section 20. Specifically, the data driver 53 performs digital/analog (D/A) conversion based on the image signal S1 to thereby generate the pixel signal as an analog signal and supply it to each pixel Pix.

FIG. 3 shows one example of a circuit diagram of a sub-pixel SPix configuring the pixel Pix of the liquid crystal display section 20. Each pixel Pix has three sub-pixels SPix corresponding to red, green, and blue, respectively. The sub-pixel SPix includes a thin film transistor (TFT) element Tr, a liquid crystal element LC, and a holding capacitance element Cs. The TFT element Tr is configured by e.g. a metal oxide semiconductor-field effect transistor (MOS-FET) and the gate is connected to a gate line GCL. In addition, the source is connected to a data line SGL and the drain is connected to one terminal of the liquid crystal element LC and one terminal of the holding capacitance element Cs. One terminal of the liquid crystal element LC is connected to the drain of the TFT element Tr and the other terminal is grounded. One terminal of the holding capacitance element Cs is connected to the drain of the TFT element Tr and the other terminal is connected to a holding capacitance line CSL. The gate line GCL is connected to the gate driver 52 and the data line SGL is connected to the data driver 53.

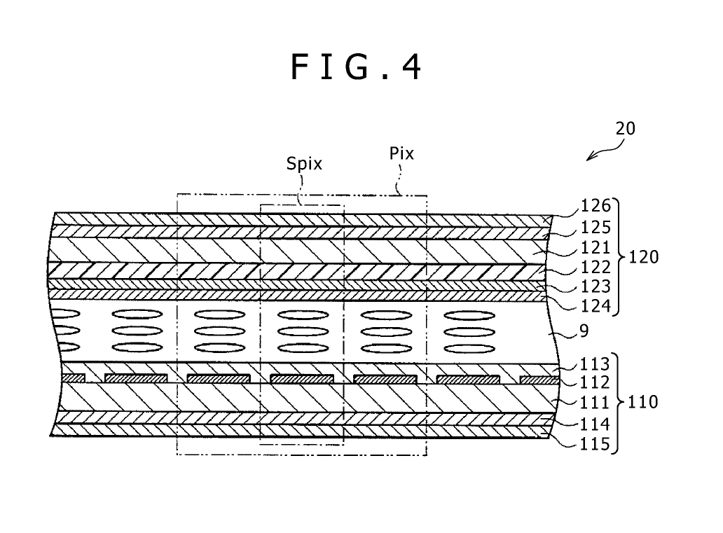

FIG. 4 shows the sectional configuration of the liquid crystal display section 20. The liquid crystal display section 20 is obtained by sealing a liquid crystal layer 9 between a drive substrate 110 and an opposing substrate 120.

The drive substrate 110 has a transparent substrate 111, pixel electrodes 112, an alignment film 113, a retardation film 114, and a polarization film 115. The transparent substrate 111 is configured by e.g. glass and the TFT elements Tr (not shown) and so forth are formed on the surface thereof Furthermore, the pixel electrodes 112 are formed thereon. The pixel electrode 112 is configured by a transparent electrically-conductive film of e.g. indium tin oxide (ITO) and is supplied with the pixel signal from the data driver 53 via the data line SGL and the TFT element Tr. The alignment film 113 is formed on the pixel electrodes 112. The retardation film 114 and the polarization film 115 are formed in that order over the surface of the transparent substrate 111 as the opposite surface of the surface over which these pixel electrodes 112 and so forth are formed.

The opposing substrate 120 has a transparent substrate 121, a color filter layer 122, a common electrode 123, an alignment film 124, a retardation film 125, and a polarization film 126. The transparent substrate 121 is configured by e.g. glass similarly to the transparent substrate 111. The color filter layer 122 is formed on the surface of the transparent substrate 121. In the color filter layer 122, color filters of three colors of red, green, and blue are formed at parts corresponding to the respective pixel electrodes 112. Furthermore, the common electrode 123 is formed on the color filter layer 122. The common electrode 123 is configured by a transparent electrically-conductive film of e.g. ITO similarly to the pixel electrode 112, and is provided in common across positions corresponding to the plural pixel electrodes 112. The alignment film 124 is formed on the common electrode 123. The retardation film 125 and the polarization film 126 are formed in that order over the surface of the transparent substrate 121 as the opposite surface of the surface over which the common electrode 123 and so forth are formed.

The retardation films 114 and 125 are configured by triacetylcellulose (TAC). However, the material is not limited thereto. Instead of this, e.g. a cycloolefin polymer (COP) may be used to configure them. In these retardation films 114 and 125, a retardation value R0 of the in-plane direction is set smaller than a retardation value Rth of the thickness direction as described later. This allows the display device 1 to achieve a wide viewing angle in e.g. black displaying. Furthermore, it is more preferable for these retardation films 114 and 125 to have a so-called reverse wavelength dispersion characteristic, in which the refractive index anisotropy decreases along with a decrease in the wavelength of light. In this case, in the display device 1, it is possible to reduce the possibility that chromaticity deviation occurs when the display device 1 is viewed from an oblique direction with respect to the display screen.

The polarization films 115 and 126 each allow the transmission of only light polarized in a predetermined direction and are so bonded as to have the transmission axes intersecting each other, i.e. as to be in the crossed-Nicols state.

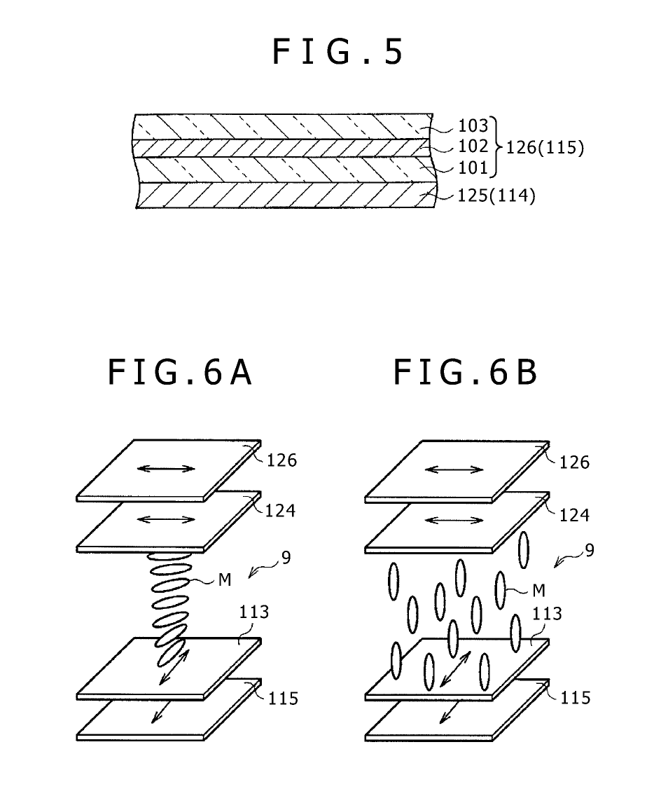

FIG. 5 shows a sectional view of the polarization film 126 together with the retardation film 125. The polarization film 126 has a polarizer 102 that realizes the polarization function and protective layers 101 and 103 that are so disposed as to sandwich the polarizer 102 and are for protecting the polarizer 102. The protective layers 101 and 103 are configured by e.g. TAC. In this example, the protective layers 101 and 103 do not have the function as the retardation film. That is, the retardation values R0 and Rth in the protective layers 101 and 103 are sufficiently lower than those of the retardation films 114 and 125.

The liquid crystal layer 9 can change transmittance T of light based on the alignment direction and is configured by e.g. a twisted nematic (TN) liquid crystal that carries out normally-white operation. A liquid crystal molecule M of the liquid crystal layer 9 has positive dielectric constant anisotropy and the refractive index of the long axis direction is higher than that of the short axis direction.

Each pixel electrode 112 configures the sub-pixel SPix together with the parts corresponding to the pixel electrode 112, such as the liquid crystal layer 9 and the color filter layer 122. The respective sub-pixels SPix of red, green, and blue configure the pixel Pix.

Based on such a configuration, in the liquid crystal display section 20, the transmittance of light in the liquid crystal layer 9 is modulated depending on the potential difference between the pixel electrode 112 and the common electrode 123, so that displaying is performed.

FIGS. 6A and 6B schematically show the operation of the liquid crystal layer 9. FIG. 6A shows the case in which a voltage is not applied between the pixel electrode 112 and the common electrode 123 and FIG. 6B shows the case in which this voltage is applied.

When the voltage is not applied, as shown in FIG. 6A, the long axis of the liquid crystal molecule M of the liquid crystal layer 9 is in parallel to the substrate surfaces of the drive substrate 110 and the opposing substrate 120. The long axis of the liquid crystal molecule M near the alignment film 113 is aligned in a predetermined direction by the alignment film 113 and the long axis of the liquid crystal molecule M near the alignment film 124 is aligned in a predetermined direction by the alignment film 124. At this time, the alignment direction of the liquid crystal molecule M aligned by the alignment film 113 and the alignment direction of the liquid crystal molecule M aligned by the alignment film 124 intersect with each other and the liquid crystal molecules M inside the liquid crystal layer 9 are so aligned as to be twisted. At this time, light incident from one side (e.g. lower side) of the liquid crystal display section 20 is polarized by the polarization film 115 and the polarization direction thereof is twisted in accordance with the alignment of the liquid crystal molecules M in the liquid crystal layer 9. Then, this light is transmitted through the polarization film 126 to be output from the other side (e.g. upper side). In this manner, in the liquid crystal display section 20, light is transmitted and so-called white displaying is performed when the voltage is not applied.

On the other hand, when the voltage is applied, as shown in FIG. 6B, the long axis of the liquid crystal molecule M of the liquid crystal layer 9 is perpendicular to the substrate surfaces of the drive substrate 110 and the opposing substrate 120. At this time, light incident from one side (e.g. lower side) of the liquid crystal display section 20 is polarized by the polarization film 115 and is transmitted through the liquid crystal layer 9 with the polarization direction kept. Then, this light is blocked by the polarization film 126. In this manner, in the liquid crystal display section 20, light is blocked and so-called black displaying is performed when the voltage is applied.

As above, the liquid crystal display section 20 performs white displaying when the voltage is not applied between the pixel electrode 112 and the common electrode 123 and performs black displaying when the voltage is applied. That is, the liquid crystal display section 20 carries out normally-white operation.

The liquid crystal layer 9 corresponds to one specific example of the “liquid crystal layer” in the first display device of an embodiment of the present disclosure. One of the drive substrate 110 and the opposing substrate 120 corresponds to one specific example of the “first substrate” in an embodiment of the present disclosure and the other corresponds to one specific example of the “second substrate” in an embodiment of the present disclosure.

### Operation and Action

The operation and action of the display device 1 of the present embodiment will be described below.

(Outline of Overall Operation)

First, with reference to FIG. 1, the outline of the overall operation of the display device 1 will be described. The control section 41 controls the backlight drive section 42 and the display drive section 50 based on the image signal Sdisp supplied from the external. The backlight drive section 42 drives the backlight 30. The backlight 30 outputs surface-emitted light to the liquid crystal display section 20. The display drive section 50 drives the liquid crystal display section 20 based on the image signal S supplied from the control section 41. The liquid crystal display section 20 performs displaying by modulating the light output from the backlight 30.

(Characteristics Relating to Viewing Angle)

In the display device 1, the retardation films 114 and 125 are provided in the liquid crystal display section 20 and thereby widening of the viewing angle in black displaying of the display device 1 is achieved. Details thereof will be described below.

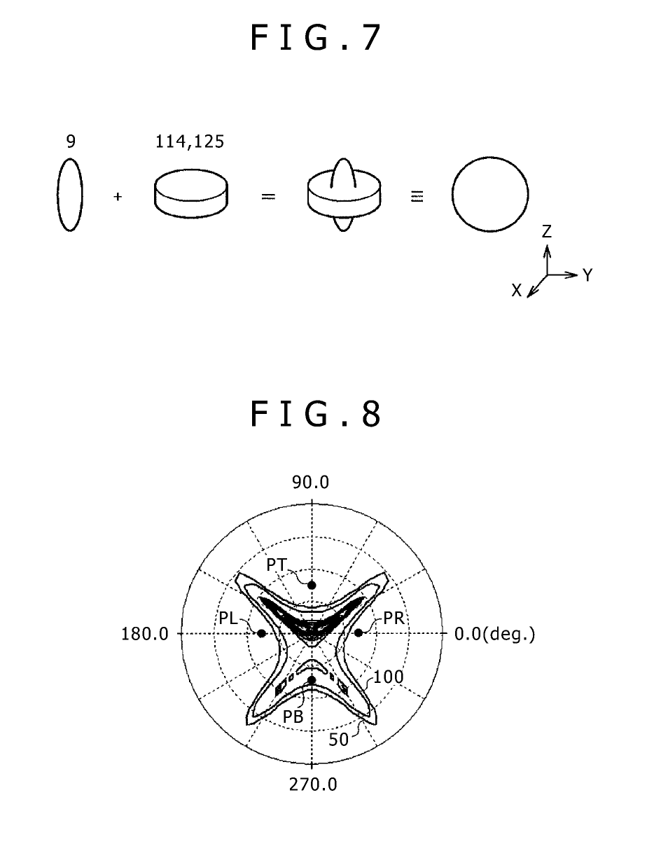

FIG. 7 is a diagram for schematically explaining the widening of the viewing angle in black displaying by the retardation films 114 and 125. In this diagram, the x direction and the y direction indicate directions parallel to the drive substrate 110 and the opposing substrate 120 and the z direction indicates the direction perpendicular to these substrates. Furthermore, each shape represents the magnitude of the refractive index in the respective directions of the x, y, and z directions. For example, a shape elongated along the z direction means that the refractive index of the z direction is high.

In black displaying, the long axis of the liquid crystal molecule M of the liquid crystal layer 9 is oriented in the direction perpendicular to the substrate (z direction) as shown in FIG. 6B, and a refractive index nz of the z direction is higher than a refractive index nx of the x direction and a refractive index ny of the y direction as shown in FIG. 7. On the other hand, in the retardation films 114 and 125, the refractive index nz of the z direction is lower than the refractive index nx of the x direction and the refractive index ny of the y direction as shown in FIG. 7. Thus, in the liquid crystal display section 20, the characteristics of the liquid crystal layer 9 and the retardation films 114 and 125 compensate for each other. Accordingly, the refractive indexes nx, ny, and nz of the x, y, and z directions become almost equal to each other and the isotropic refractive index can be realized. This can widen the viewing angle in black displaying.

Next, the characteristics of the retardation films 114 and 125 will be described. In this study, the retardation value R0 of the in-plane direction and the retardation value Rth of the thickness direction are used as optical parameters of the retardation films 114 and 125. The retardation values R0 and Rth are defined by the following expressions.

R0=(nx−ny)×d (1)

Rth=((nx+ny)/2−nz)×d (2)

The refractive index nx of the x direction and the refractive index ny of the y direction have a relationship represented by the following expression.

nx≧ny (3)

Here, the x direction is defined as the slow axis and the y direction is defined as the fast axis. The slow axis in the retardation film 114 is so set as to be aligned with the alignment orientation of the long axis of the liquid crystal molecule M near the drive substrate 110 in the liquid crystal layer 9. The slow axis in the retardation film 125 is so set as to be aligned with the alignment orientation of the long axis of the liquid crystal molecule M near the opposing substrate 120 in the liquid crystal layer 9.

In the present study, the range of the desired retardation values R0 and Rth of the retardation films 114 and 125 was obtained by performing simulations on the viewing angle characteristics with the retardation values R0 and Rth set to various values. In this example, films having the same characteristics were used as the retardation film 114 and the retardation film 125.

FIG. 8 shows one example of the viewing angle characteristics relating to the contrast when the retardation values R0 and Rth are certain values. In this FIG. 8, the left-right direction corresponds to the horizontal direction of the display screen of the display device 1 and the upward-downward direction corresponds to the vertical direction of the display screen. The contour lines in the diagram show the contrast and indicate that the contrast is higher when the distance from the center is shorter. The contrast shows the ratio between white displaying and black displaying and therefore indicates that the viewing angle of the black displaying is also wider when the viewing angle of the contrast is wider.

For evaluation of the viewing angle characteristics with various retardation values R0 and Rth, a parameter MINCR was introduced as the parameter indicating the viewing angle of the contrast in the present study. This parameter MINCR is defined as the minimum value of the contrast (parameter MINCR) at four positions of a point PR (orientation: 0 degrees, polar angle: 30 degrees), a point PT (orientation: 90 degrees, polar angle: 30 degrees), a point PL (orientation: 180 degrees, polar angle: 30 degrees), and a point PB (orientation: 270 degrees, polar angle: 30 degrees) in FIG. 8. The polar angle of 30 degrees corresponds to the maximum value of the general observation angle (0 degrees to 30 degrees) recommended for viewing of the display device by the viewer. That is, the parameter MINCR indicates that the viewing angle is wider when the value thereof is larger and the viewing angle is narrower when the value thereof is smaller.

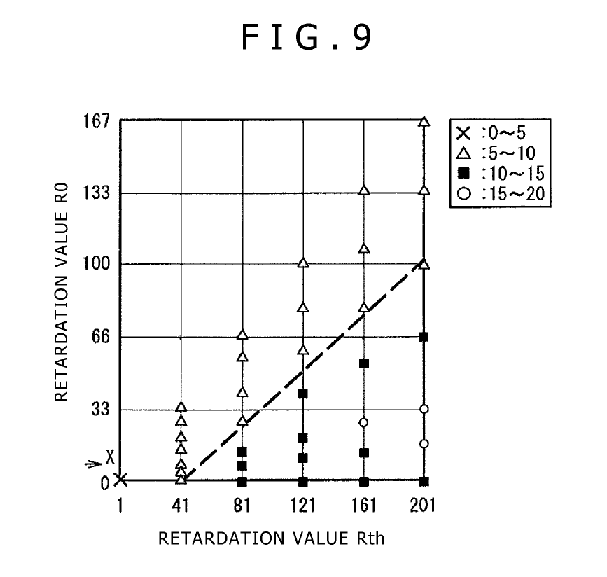

FIG. 9 shows the relationship between the parameter MINCR and the retardation values R0 and Rth of the retardation films 114 and 125. In FIG. 9, the abscissa indicates the retardation value Rth of the thickness direction and the ordinate indicates the retardation value R0 of the in-plane direction. Furthermore, symbol x (cross) indicates that the parameter MINCR is 0 or larger but smaller than 5. Symbol Δ (triangle) indicates that the parameter MINCR is 5 or larger but smaller than 10. Symbol □ (square) indicates that the parameter MINCR is 10 or larger but smaller than 15. Symbol ∘ (circle) indicates that the parameter MINCR is 15 or larger but smaller than 20.

As shown in FIG. 9, when the retardation value R0 is smaller and the retardation value Rth is larger, the parameter MINCR is larger and thus the viewing angle is wider. Specifically, when the retardation values R0 and Rth fall within the range below the dashed line in FIG. 9, the parameter MINCR is at least 10 and thus the viewing angle is wide. This range of the retardation values R0 and Rth can be represented by the following relationship expression.

R0≦(⅝)×Rth−25 (A)

As described above, in the display device 1, the retardation values R0 and Rth relating to each of the retardation films 114 and 125 are so set as to satisfy expression (A) and thus the viewing angle can be widened.

Furthermore, the retardation films 114 and 125 are configured by e.g. TAC or COP as described above and are inexpensive differently from a dedicated member such as a WV film. Thus, the cost can be reduced. Moreover, in the case of TAC or COP, the retardation values R0 and Rth can be changed by stretching the film in an in-plane direction and therefore the desired retardation values R0 and Rth can be obtained at lower cost.

### Effects

As described above, in the present embodiment, the viewing angle can be widened because the retardation films having the retardation values in the predetermined range satisfying expression (A) are used.

Furthermore, in the present embodiment, the cost can be reduced because the retardation films are configured by using TAC or COP.

In addition, in the present embodiment, the retardation films have the reverse wavelength dispersion characteristic. This can reduce the possibility that chromaticity deviation occurs when the display device is viewed from an oblique direction with respect to the display screen.

### Modification Example 1-1

In the above-described embodiment, the protective layers 101 and 103 of the polarization films 115 and 126 do not have the function as the retardation film. However, the configuration is not limited thereto. Instead of this, they may have the function as the retardation film for example.

In this case, for example, the retardation film 114 and the polarization film 115 may function as one retardation film and the retardation film 125 and the polarization film 126 may function as one retardation film. Specifically, the following configuration is possible regarding the retardation film 125 and the polarization film 126 for example. The total value of the retardation value of the in-plane direction in the retardation film 125 and the retardation value of the in-plane direction in the protective layer 101 of the polarization film 126 is defined as the retardation value R0. Similarly, the total value of the retardation values of the thickness direction in these two components is defined as the retardation value Rth. These retardation values R0 and Rth are so set as to satisfy expression (A).

Alternatively, for example, the retardation films 114 and 125 may be omitted and the polarization films 115 and 126 may be each used also as the retardation film. Specifically, the following configuration is possible regarding the polarization film 126 for example. The protective layer 101 is used as the retardation film and the retardation value R0 of the in-plane direction thereof and the retardation value Rth of the thickness direction are so set as to satisfy expression (A).

### Modification Example 1-2

In the above-described embodiment, the retardation film 114 and the retardation film 125 have the same characteristics. However, the configuration is not limited thereto and they may have characteristics different from each other for example. In this case, the following configuration is possible for example. The average value of the respective retardation values of the in-plane direction in these two retardation films 114 and 125 is defined as the retardation value R0 and the average value of the respective retardation values of the thickness direction is defined as the retardation value Rth. These retardation values R0 and Rth are so set as to satisfy expression (A).

### Modification Example 1-3

In the above-described embodiment, both the retardation film 114 and the retardation film 125 are provided. However, the configuration is not limited thereto. Instead of this, only one of the retardation films 114 and 125 may be provided for example. In this case, asymmetry possibly arises in the viewing angle characteristics for example. However, this configuration can be applied to applications that can permit this asymmetry.

### 2. Second Embodiment

A stereoscopic display device 2 according to a second embodiment will be described below. The present embodiment is a stereoscopic display device of a parallax barrier system using a liquid crystal barrier. A barrier device according to an embodiment of the present disclosure is embodied by the present embodiment and therefore will be described together. Substantially the same constituent part as that in the display device 1 according to the above-described first embodiment is given the same numeral and description thereof is accordingly omitted.

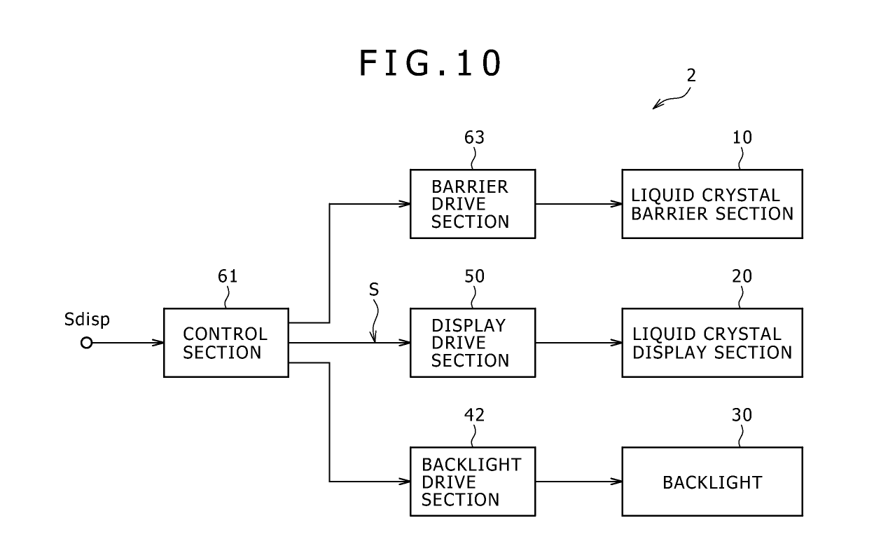

FIG. 10 shows one configuration example of the stereoscopic display device 2. The stereoscopic display device 2 includes a control section 61, a barrier drive section 63, and a liquid crystal barrier section 10.

The control section 61 is a circuit that supplies a control signal to each of the backlight drive section 42, the display drive section 50, and the barrier drive section 63 based on the image signal Sdisp supplied from the external and controls them so that they may operate in synchronization with each other. Specifically, the control section 61 supplies the backlight control signal to the backlight drive section 42 and supplies the image signal S based on the image signal Sdisp to the display drive section 50. Furthermore, it supplies a barrier control signal to the barrier drive section 63. The image signal S is composed of image signals SA and SB each including plural (six, in this example) viewpoint images as described later when the stereoscopic display device 2 performs stereoscopic displaying.

The barrier drive section 63 drives the liquid crystal barrier section 10 based on the barrier control signal supplied from the control section 61. The liquid crystal barrier section 10 transmits (open operation) or blocks (close operation) light that is output from the backlight 30 and transmitted through the liquid crystal display section 20, and has plural opened/closed portions 11 and 12 (to be described later) configured by using a liquid crystal.

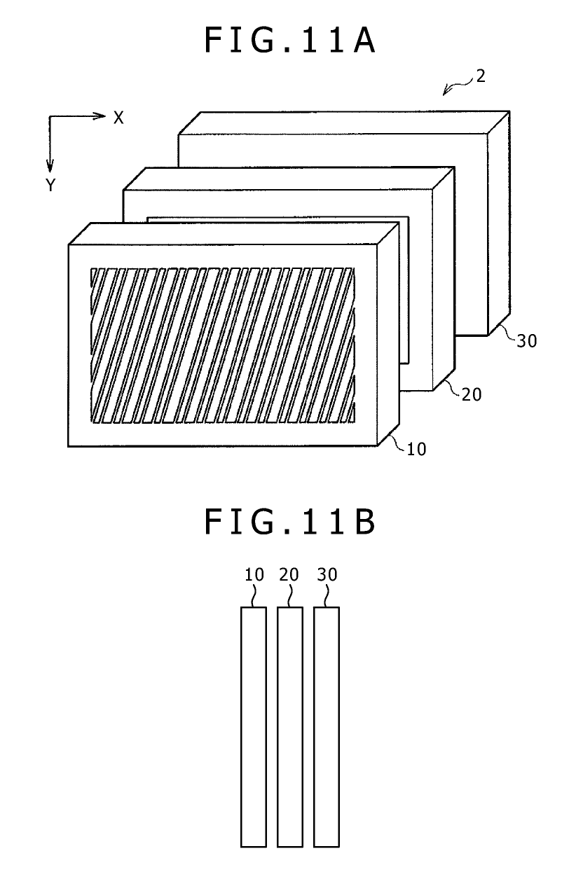

FIGS. 11A and 11B show one configuration example of the major part of the stereoscopic display device 2. FIG. 11A shows an exploded perspective configuration of the stereoscopic display device 2 and FIG. 11B shows a side view of the stereoscopic display device 2. As shown in FIGS. 11A and 11B, in the stereoscopic display device 2, these respective parts are disposed in the order of the backlight 30, the liquid crystal display section 20, and the liquid crystal barrier section 10. That is, light output from the backlight 30 reaches the viewer via the liquid crystal display section 20 and the liquid crystal barrier section 10.

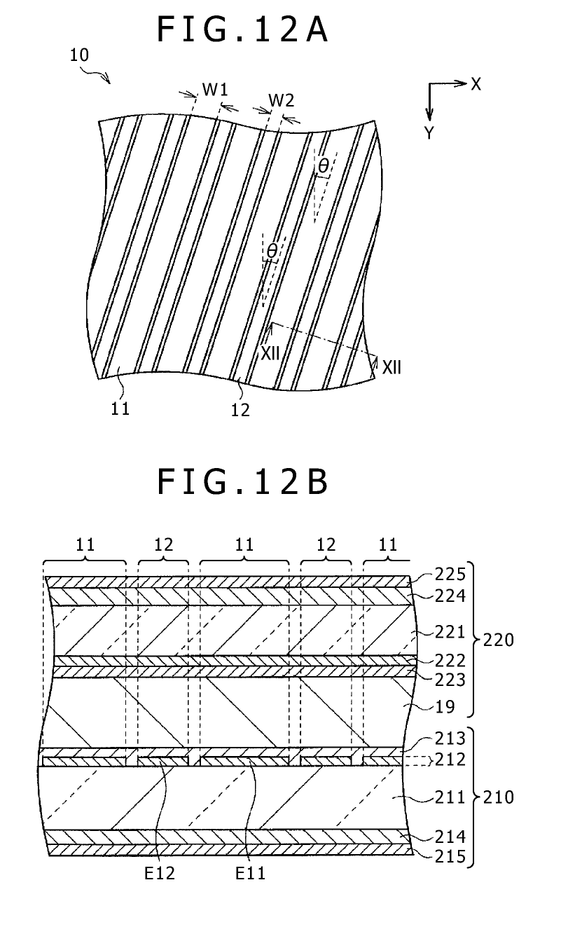

FIGS. 12A and 12B show one configuration example of the liquid crystal barrier section 10. FIG. 12A shows the arrangement configuration of the opened/closed portions in the liquid crystal barrier section 10 and FIG. 12B shows a sectional configuration of arrow direction XII-XII in the liquid crystal barrier section 10 of FIG. 12A. The liquid crystal barrier section 10 carries out normally-white operation. That is, the liquid crystal barrier section 10 transmits light when being not driven.

The liquid crystal barrier section 10 is a so-called parallax barrier and has the plural opened/closed portions (liquid crystal barriers) 11 and 12 that transmit or block light as shown in FIG. 12A. These opened/closed portions 11 and 12 carry out different operation depending on whether the stereoscopic display device 2 performs normal displaying (two-dimensional displaying) or stereoscopic displaying. Specifically, the opened/closed portion 11 is in the opened state (transmissive state) in normal displaying and is in the closed state (blocking state) in stereoscopic displaying as described later. The opened/closed portion 12 is in the opened state (transmissive state) in normal displaying and carries out open/close operation in a time-division manner in stereoscopic displaying as described later.

These opened/closed portions 11 and opened/closed portions 12 are so provided as to extend along one direction in the XY plane (in this example, e.g. direction inclined from the vertical direction Y by a predetermined angle θ). The angle θ can be set to e.g. 18 degrees. The width W1 of the opened/closed portion 11 and the width W2 of the opened/closed portion 12 are different from each other and e.g. a relationship of W1>W2 holds in this example. However, the magnitude relationship of the widths of the opened/closed portions 11 and 12 is not limited thereto and a relationship of W1<W2 or W1=W2 may be employed. Such opened/closed portions 11 and 12 include a liquid crystal layer 19 to be described later and the opened state and closed state are switched by a drive voltage to this liquid crystal layer 19.

As shown in FIG. 12B, the liquid crystal barrier section 10 is obtained by sealing the liquid crystal layer 19 between a drive substrate 210 and an opposing substrate 220.

The drive substrate 210 has a transparent substrate 211, a transparent electrode layer 212, an alignment film 213, a retardation film 214, and a polarization film 215. The transparent substrate 211 is configured by e.g. glass. The transparent electrode layer 212 configured by a transparent electrically-conductive film of e.g. ITO is formed on the transparent substrate 211. The alignment film 213 is formed on the transparent electrode layer 212. The retardation film 214 and the polarization film 215 are formed in that order over the surface of the transparent substrate 211 as the opposite surface of the surface over which the transparent electrode layer 212 and so forth are formed.

The opposing substrate 220 has a transparent substrate 221, a transparent electrode layer 222, an alignment film 223, a retardation film 224, and a polarization film 225. The transparent substrate 221 is configured by e.g. glass similarly to the transparent substrate 211. The transparent electrode layer 222 is formed on the transparent substrate 221. The transparent electrode layer 222 is configured by a transparent electrically-conductive film of e.g. ITO similarly to the transparent electrode layer 212. The alignment film 223 is formed on the transparent electrode layer 222. The retardation film 224 and the polarization film 225 are formed in that order over the surface of the transparent substrate 221 as the opposite surface of the surface over which the transparent electrode layer 222 and so forth are formed.

The retardation films 214 and 224 are configured similarly to the retardation films 114 and 125 according to the above-described first embodiment and have the reverse wavelength dispersion characteristic. In addition, the retardation value R0 of the in-plane direction and the retardation value Rth of the thickness direction are so set as to satisfy expression (A).

The polarization films 215 and 225 are configured similarly to the polarization films 115 and 126 according to the above-described first embodiment and are so bonded as to be in the crossed-Nicols state.

The liquid crystal layer 19 is configured similarly to the liquid crystal layer 9 according to the above-described first embodiment and is configured by e.g. a twisted nematic (TN) liquid crystal that carries out normally-white operation. Thus, the operation of the liquid crystal layer 19 is the same as that of the liquid crystal layer 9 (FIGS. 6A and 6B).

The transparent electrode layer 212 has transparent electrodes E11 and transparent electrodes E12. The transparent electrode layer 222 is provided as an electrode common to the respective opened/closed portions 11 and 12. The transparent electrode E11 of the transparent electrode layer 212 and the parts corresponding to this transparent electrode E11 in the liquid crystal layer 19 and the transparent electrode layer 222 configure the opened/closed portion 11. Similarly, the transparent electrode E12 of the transparent electrode layer 212 and the parts corresponding to this transparent electrode E12 in the liquid crystal layer 19 and the transparent electrode layer 222 configure the opened/closed portion 12.

Based on this configuration, in the liquid crystal barrier section 10, a voltage is selectively applied to the transparent electrodes E11 and E12 and liquid crystal alignment depending on the voltage is obtained in the liquid crystal layer 19. Thereby, open and close operation for each of the opened/closed portions 11 and 12 can be carried out. Specifically, the voltage is applied to the transparent electrode layer 212 (transparent electrodes E11 and E12) and the transparent electrode layer 222. When the potential difference thereof becomes larger, the transmittance of light in the liquid crystal layer 19 decreases and the opened/closed portions 11 and 12 become the blocking state (closed state). On the other hand, when the potential difference becomes smaller, the transmittance of light in the liquid crystal layer 19 increases and the opened/closed portions 11 and 12 become the transmissive state (opened state).

In the liquid crystal barrier section 10, the plural opened/closed portions 12 configure groups and the plural opened/closed portions 12 that belong to the same group carry out open operation and close operation at the same timing in stereoscopic displaying. A description will be made below about the group of the opened/closed portions 12.

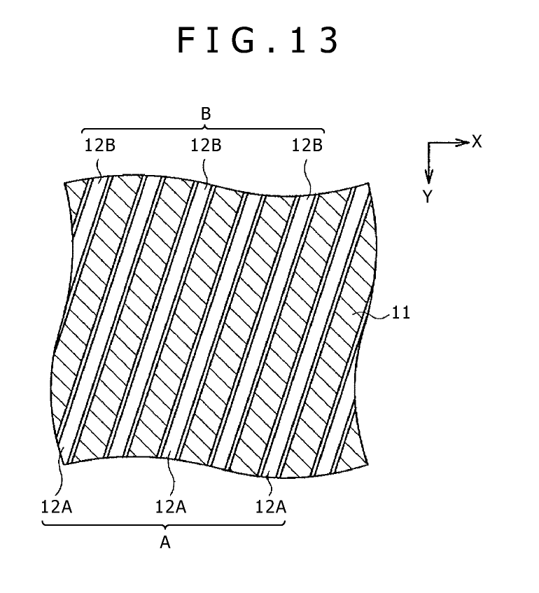

FIG. 13 shows a group configuration example of the opened/closed portions 12. The opened/closed portions 12 configure two groups in this example. Specifically, the plural juxtaposed opened/closed portions 12 alternately configure a group A and a group B. Hereinafter, “opened/closed portion 12A” is accordingly used as the generic term of the opened/closed portions 12 that belong to the group A. Similarly, “opened/closed portion 12B” is accordingly used as the generic term of the opened/closed portions 12 that belong to the group B.

In stereoscopic displaying, the barrier drive section 63 performs driving in such a manner that the plural opened/closed portions 12 that belong to the same group carry out open/close operation at the same timing. Specifically, the barrier drive section 63 drives the plural opened/closed portions 12A, which belong to the group A, and the plural opened/closed portions 12B, which belong to the group B, in such a manner that the opened/closed portions 12A and 12B alternately carry out open/close operation in a time-division manner as described later.

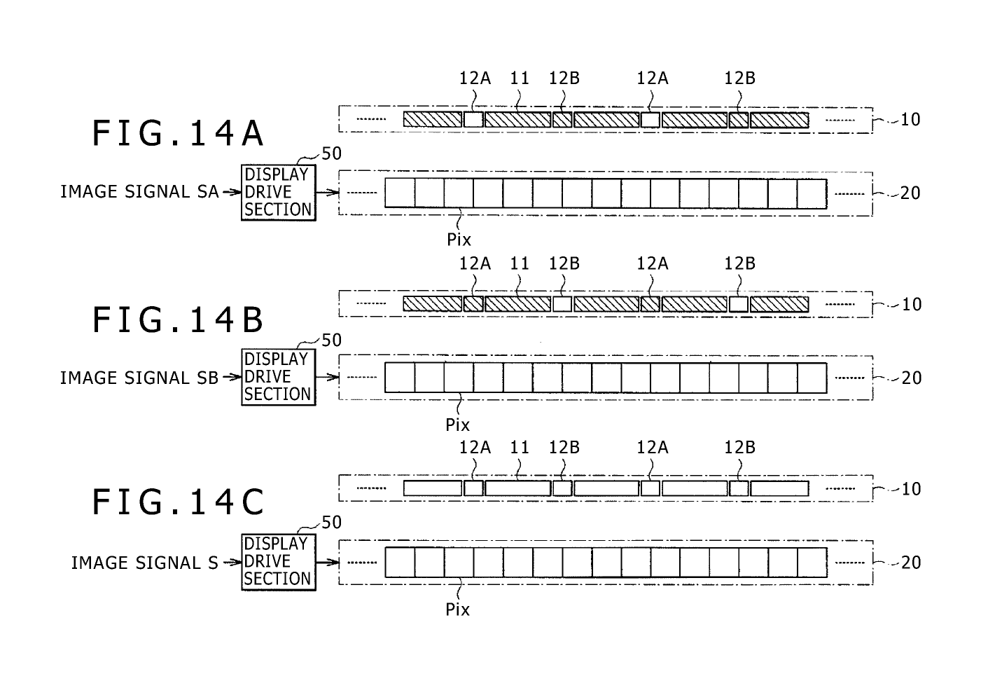

FIGS. 14A to 14C schematically show, by using a sectional structure, the state of the liquid crystal barrier section 10 when stereoscopic displaying and normal displaying (two-dimensional displaying) are performed. FIG. 14A shows one state in the stereoscopic displaying. FIG. 14B shows the other state in the stereoscopic displaying. FIG. 14C shows the state in the normal displaying. In the liquid crystal barrier section 10, the opened/closed portions 11 and the opened/closed portions 12 (opened/closed portions 12A and 12B) are alternately disposed. In this example, the opened/closed portions 12A are provided at a rate of one per six pixels Pix of the liquid crystal display section 20. Similarly, the opened/closed portions 12B are provided at a rate of one per six pixels Pix of the liquid crystal display section 20. In FIGS. 14A to 14C, the opened/closed portions by which light is blocked, of the opened/closed portions 11, 12A, and 12B of the liquid crystal barrier section 10, are shown by hatched lines.

In stereoscopic displaying, the image signals SA and SB are alternately supplied to the display drive section 50 and the liquid crystal display section 20 performs displaying based on them. In the liquid crystal barrier section 10, the opened/closed portions 12 (opened/closed portions 12A and 12B) carry out open/close operation in a time-division manner and the opened/closed portions 11 keep the closed state (blocking state). Specifically, when the image signal SA is supplied, as shown in FIG. 14A, the opened/closed portion 12A becomes the opened state and the opened/closed portion 12B becomes the closed state. In the liquid crystal display section 20, six pixels Pix that are disposed at the positions corresponding to the opened/closed portion 12A and are adjacent to each other perform displaying corresponding to six viewpoint images included in the image signal SA as described later. Due to this, the viewer sees different viewpoint images by the left eye and the right eye for example to thereby perceive the displayed image as a stereoscopic image as described later. Similarly, when the image signal SB is supplied, as shown in FIG. 14B, the opened/closed portion 12B becomes the opened state and the opened/closed portion 12A becomes the closed state. In the liquid crystal display section 20, six pixels Pix that are disposed at the positions corresponding to the opened/closed portion 12B and are adjacent to each other perform displaying corresponding to six viewpoint images included in the image signal SB as described later. Due to this, the viewer sees different viewpoint images by the left eye and the right eye for example to thereby perceive the displayed image as a stereoscopic image as described later. In this manner, images are displayed by alternately opening the opened/closed portions 12A and the opened/closed portions 12B in the stereoscopic display device 2. Thereby, the resolution of the display device can be enhanced as described later.

In normal displaying (two-dimensional displaying), as shown in FIG. 14C, both the opened/closed portions 11 and the opened/closed portions 12 (opened/closed portions 12A and 12B) keep the opened state (transmissive state) in the liquid crystal barrier section 10. This allows the viewer to see a normal two-dimensional image displayed on the liquid crystal display section 20 based on the image signal S as it is.

The liquid crystal display section 20 corresponds to one specific example of the “display section” of an embodiment of the present disclosure. The liquid crystal barrier section 10 corresponds to one specific example of the “barrier section” of an embodiment of the present disclosure. The opened/closed portions 11 and 12 correspond to one specific example of the “liquid crystal barrier” of an embodiment of the present disclosure. The opened/closed portion 12 corresponds to one specific example of the “first-series liquid crystal barrier” of an embodiment of the present disclosure and the opened/closed portion 11 corresponds to one specific example of the “second-series liquid crystal barrier” of an embodiment of the present disclosure. The liquid crystal layer 19 corresponds to one specific example of the “liquid crystal layer” in the second display device and the barrier device according to an embodiment of the present disclosure. One of the drive substrate 210 and the opposing substrate 220 corresponds to one specific example of the “first substrate” in an embodiment of the present disclosure and the other corresponds to one specific example of the “second substrate” in an embodiment of the present disclosure.

Next, with reference to FIG. 10, the outline of the overall operation of the stereoscopic display device 2 will be described. The control section 61 supplies the control signal to each of the backlight drive section 42, the display drive section 50, and the barrier drive section 63 based on the image signal Sdisp supplied from the external and controls them so that they may operate in synchronization with each other. The backlight drive section 42 drives the backlight 30 based on the backlight control signal supplied from the control section 61. The backlight 30 outputs surface-emitted light to the liquid crystal display section 20. The display drive section 50 drives the liquid crystal display section 20 based on the image signal S supplied from the control section 61. The liquid crystal display section 20 performs displaying by modulating the light output from the backlight 30. The barrier drive section 63 drives the liquid crystal barrier section 10 based on the barrier control signal supplied from the control section 61. The opened/closed portions 11 and 12 (12A and 12B) of the liquid crystal barrier section 10 carry out open/close operation to transmit or block the light that is output from the backlight 30 and transmitted through the liquid crystal display section 20.

Next, detailed operation in stereoscopic displaying will be described.

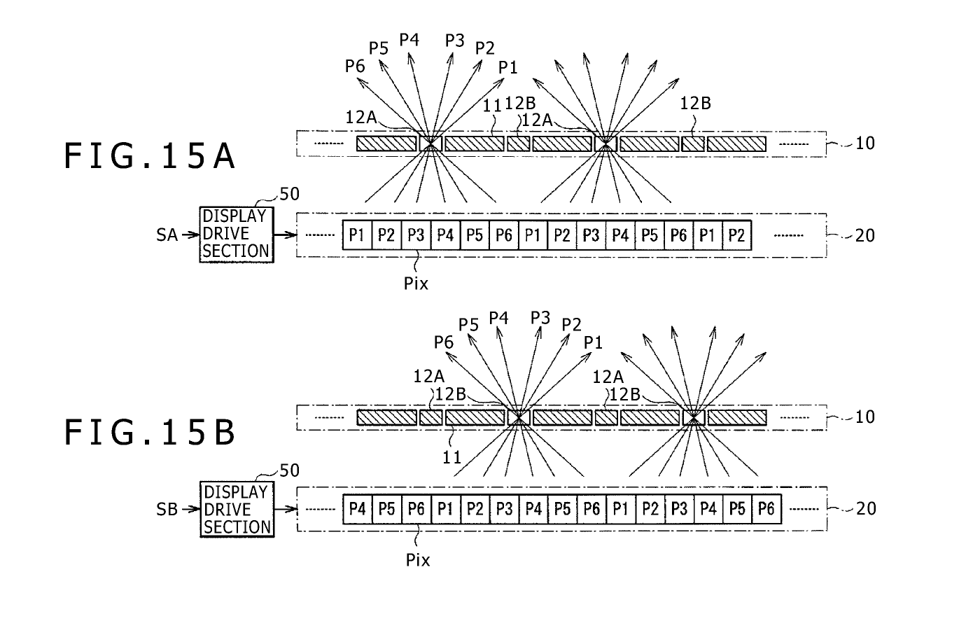

FIGS. 15A and 15B show an operation example of the liquid crystal display section 20 and the liquid crystal barrier section 10. FIG. 15A shows operation when the image signal SA is supplied and FIG. 15B shows operation when the image signal SB is supplied.

When the image signal SA is supplied, as shown in FIG. 15A, the pixels Pix of the liquid crystal display section 20 display pixel data P1 to P6 each corresponding to a respective one of six viewpoint images included in the image signal SA. At this time, the pixel data P1 to P6 are each displayed by the pixel Pix disposed near the opened/closed portion 12A. When the image signal SA is supplied, in the liquid crystal barrier section 10, control is so carried out that the opened/closed portions 12A are in the opened state (transmissive state) and the opened/closed portions 12B are in the closed state. The light emitted from each pixel Pix of the liquid crystal display section 20 is so output that the angle is limited by the opened/closed portion 12A. The viewer sees the pixel data P3 by the left eye and sees the pixel data P4 by the right eye for example and thereby can see a stereoscopic image.

When the image signal SB is supplied, as shown in FIG. 15B, the pixels Pix of the liquid crystal display section 20 display the pixel data P1 to P6 each corresponding to a respective one of six viewpoint images included in the image signal SB. At this time, the pixel data P1 to P6 are each displayed by the pixel Pix disposed near the opened/closed portion 12B. When the image signal SB is supplied, in the liquid crystal barrier section 10, control is so carried out that the opened/closed portions 12B are in the opened state (transmissive state) and the opened/closed portions 12A are in the closed state. The light emitted from each pixel Pix of the liquid crystal display section 20 is so output that the angle is limited by the opened/closed portion 12B. The viewer sees the pixel data P3 by the left eye and sees the pixel data P4 by the right eye for example and thereby can see a stereoscopic image.

In this manner, the viewer sees different pixel data of the pixel data P1 to P6 by the left eye and the right eye, so that the viewer can perceive the image data as a stereoscopic image. Furthermore, due to image displaying through alternate opening of the opened/closed portions 12A and the opened/closed portions 12B in a time-division manner, the viewer sees images displayed at positions shifted from each other with averaging. Thus, the stereoscopic display device 2 can realize a resolution twice that of a display device having only the opened/closed portions 12A. In other words, it is enough that the resolution of the stereoscopic display device 2 is ⅓ (=⅙×2) of that of two-dimensional displaying.

Also in the stereoscopic display device 2, the retardation values R0 and Rth relating to each of the retardation films 214 and 224 are so set as to satisfy expression (A) similarly to the display device 1 according to the above-described first embodiment. Thus, the viewing angle can be widened. Furthermore, the retardation films 214 and 224 are configured by e.g. TAC or COP similarly to the retardation films 114 and 125 according to the above-described first embodiment. Thus, the cost can be reduced.

As described above, in the present embodiment, the retardation films are applied to the liquid crystal barrier section of the stereoscopic display device. Therefore, the viewing angle of the stereoscopic display device can be widened and the cost can be reduced. Other advantageous effects are the same as those of the above-described first embodiment.

### Modification Example 2-1

In the above-described embodiment, the liquid crystal display section 20 and the backlight 30 are used. However, the configuration is not limited thereto. Instead of this, e.g. a display section based on electro luminescence (EL) may be used.

### Modification Example 2-2

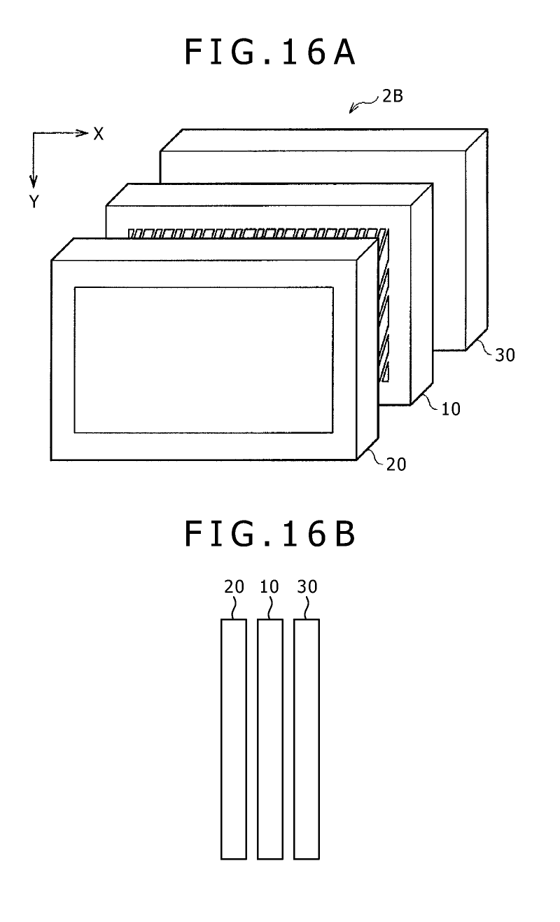

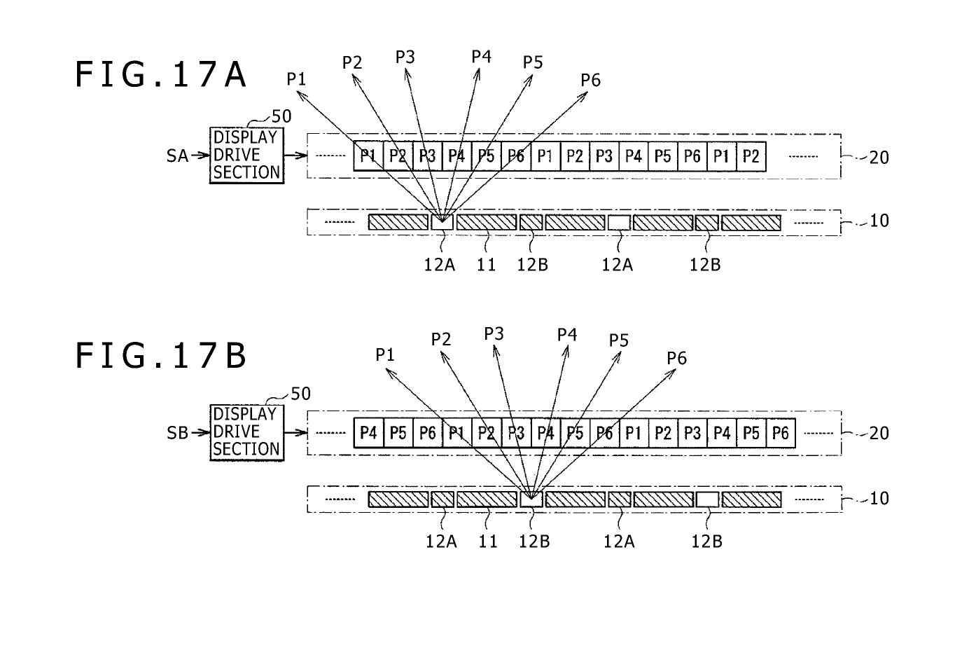

In the above-described embodiment, the backlight 30, the liquid crystal display section 20, and the liquid crystal barrier section 10 are disposed in that order. However, the configuration is not limited thereto. Instead of this, they may be disposed in the order of the backlight 30, the liquid crystal barrier section 10, and the liquid crystal display section 20 as shown in FIGS. 16A and 16B. FIGS. 17A and 17B show an operation example of the liquid crystal display section 20 and the liquid crystal barrier section 10 according to the present modification example. FIG. 17A shows operation when the image signal SA is supplied and FIG. 17B shows operation when the image signal SB is supplied. In the present modification example, light output from the backlight 30 is first incident on the liquid crystal barrier section 10. Then, of this light, light transmitted through the opened/closed portions 12A and 12B is modulated in the liquid crystal display section 20 and outputs six viewpoint images.

### Modification Example 2-3

In the above-described embodiment, the opened/closed portions 12 configure two groups. However, the configuration is not limited thereto. Instead of this, they may configure three or more groups for example. This can further improve the resolution of displaying. Details thereof will be described below.

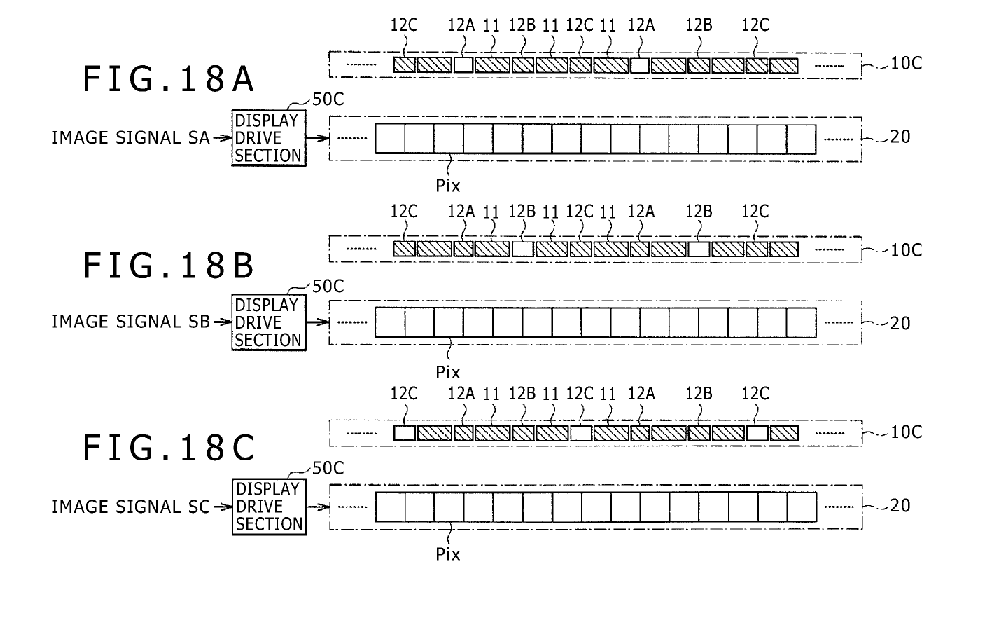

FIGS. 18A to 18C show an example in which the opened/closed portions 12 configure three groups A, B, and C. Similarly to the above-described embodiment, opened/closed portions 12A are the opened/closed portions 12 that belong to the group A. Opened/closed portions 12B are the opened/closed portions 12 that belong to the group B and opened/closed portions 12C are the opened/closed portions 12 that belong to the group C.

By displaying images through alternate opening of the opened/closed portions 12A, 12B, and 12C in a time-division manner in this manner, the stereoscopic display device according to this modification example can realize the resolution three times that of a display device having only the opened/closed portions 12A. In other words, it is enough that the resolution of this stereoscopic display device is ½ (=⅙×3) of that of two-dimensional displaying.

### Modification Example 2-4

In the above-described embodiment, the image signals SA and SB include six viewpoint images. However, the configuration is not limited thereto and they may include five or less viewpoint images or seven or more viewpoint images. In this case, the relationship shown in FIGS. 14A to 14C between the opened/closed portions 12A and 12B of the liquid crystal barrier section 10 and the pixels Pix also changes. Specifically, for example when the image signals SA and SB include five viewpoint images, it is preferable for the opened/closed portions 12A to be provided at a rate of one per five pixels Pix of the display section 20. Similarly, it is preferable for the opened/closed portions 12B to be provided at a rate of one per five pixels Pix of the display section 20.

### Modification Example 2-5

In the above-described embodiment, the opened/closed portions 11 and 12 are so provided as to extend along an oblique direction inclined from the vertical direction Y by the predetermined angle θ. However, the configuration is not limited thereto. Instead of this, they may be so provided as to extend along the vertical direction Y for example.

### 3. Application Examples

Application examples of the display devices and the stereoscopic display devices explained in the above-described embodiments and modification examples will be described below.

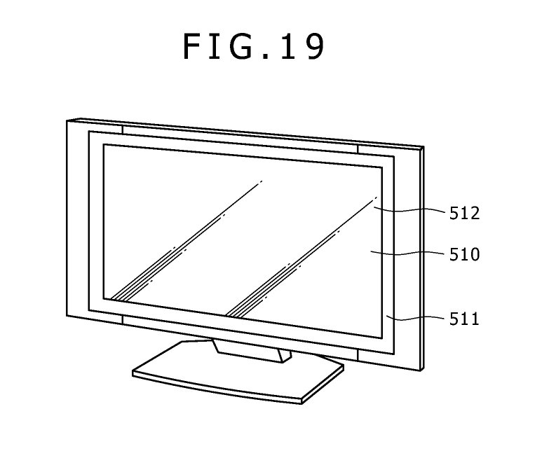

FIG. 19 shows the appearance of a television device to which the display devices and the stereoscopic display devices of the above-described embodiments and so forth are applied. This television device has e.g. a video display screen section 510 including a front panel 511 and a filter glass 512 and this video display screen section 510 is configured by the display device or the stereoscopic display device according to the above-described embodiment and so forth.

The display devices and the stereoscopic display devices of the above-described embodiments and so forth can be applied to, besides such a television device, an electronic apparatus of every field, such as digital cameras, notebook personal computers, portable terminal devices typified by cellular phones, and video camcorders. In other words, the display devices and the stereoscopic display devices of the above-described embodiments and so forth can be applied to every-field electronic apparatus that displays video.

Although the present technique is explained above by taking several embodiments and modification examples and examples of application of them to an electronic apparatus, the present technique is not limited to these embodiments and so forth and various modifications are possible.

For example, modification examples 1-1 to 1-3 according to the first embodiment may be similarly applied to the liquid crystal barrier section 10 according to the second embodiment and so forth.

The present technique can take the following configurations.

(1) A display device including

a liquid crystal layer,

a first substrate configured to include a first polarization film and a first retardation film, and

a second substrate configured to include a second polarization film and be disposed on a side on which the first retardation film, of the first polarization film and the first retardation film, is disposed, of the first substrate, with intermediary of the liquid crystal layer,

wherein an in-plane retardation value R0 of in-plane direction of the first retardation film and a thickness retardation value Rth of thickness direction of the first retardation film satisfy expression (A).

R0≦(⅝)×Rth−25 (A)

(2) The display device according to the above-described (1), wherein the first retardation film is configured by triacetylcellulose or a cycloolefin polymer.

(3) The display device according to the above-described (1) or (2), wherein the first retardation film has a reverse wavelength dispersion characteristic.

(4) The display device according to any of the above-described (1) to (3), wherein the second substrate includes a second retardation film disposed on a side of the liquid crystal layer, of the second polarization film.

(5) The display device according to the above-described (4), wherein an in-plane retardation value and a thickness retardation value of the second retardation film are substantially equal to the in-plane retardation value R0 and the thickness retardation value Rth, respectively, of the first retardation film.

(6) The display device according to the above-described (4) or (5), wherein

the first retardation film is disposed on an opposite side to the liquid crystal layer, of the first substrate, and

the second retardation film is disposed on an opposite side to the liquid crystal layer, of the second substrate.

(7) The display device according to any of the above-described (1) to (6), wherein the liquid crystal layer is configured by a TN liquid crystal that carries out normally-white operation.

(8) A display device including

a display section, and

a barrier section configured to have a liquid crystal barrier capable of being switched between an opened state and a closed state, wherein

the barrier section includes
a liquid crystal layer,
a first substrate including a polarization film and a retardation film, and
a second substrate disposed on a side on which the retardation film, of the polarization film and the retardation film, is disposed, of the first substrate, with intermediary of the liquid crystal layer, and

an in-plane retardation value R0 of in-plane direction of the retardation film and a thickness retardation value Rth of thickness direction of the retardation film satisfy expression (A).

R0≦(⅝)×Rth−25 (A)

(9) The display device according to the above-described (8), wherein the barrier section has a plurality of first-series liquid crystal barriers and a plurality of second-series liquid crystal barriers.

(10) The display device according to the above-described (9), wherein

the display device has a plurality of display modes including a two-dimensional image display mode and a three-dimensional image display mode,

in the two-dimensional image display mode, the display section displays one viewpoint image and a two-dimensional image is displayed by setting the plurality of first-series liquid crystal barriers and the plurality of second-series liquid crystal barriers to a transmissive state, and

in the three-dimensional image display mode, the display section displays a plurality of viewpoint images and a three-dimensional image is displayed by setting the plurality of first-series liquid crystal barriers to a transmissive state and setting the plurality of second-series liquid crystal barriers to a blocking state.

(11) The display device according to the above-described (10), wherein

the plurality of first-series liquid crystal barriers are divided into a plurality of barrier groups, and

in the three-dimensional image display mode, the plurality of first-series liquid crystal barriers are switched between an opened state and a closed state in a time-division manner on each barrier group basis.

(12) The display device according to any of the above-described (8) to (11), further including

a backlight, wherein

the display section is a liquid crystal display section, and

the liquid crystal display section is disposed between the backlight and the barrier section.

(13) The display device according to any of the above-described (8) to (11), further including

a backlight, wherein

the display section is a liquid crystal display section, and

the barrier section is disposed between the backlight and the liquid crystal display section.

(14) A barrier device including

a barrier section configured to have a liquid crystal barrier capable of being switched between an opened state and a closed state, wherein

the barrier section includes
a liquid crystal layer,
a first substrate including a polarization film and a retardation film, and
a second substrate disposed on a side on which the retardation film, of the polarization film and the retardation film, is disposed, of the first substrate, with intermediary of the liquid crystal layer, and

an in-plane retardation value R0 of in-plane direction of the retardation film and a thickness retardation value Rth of thickness direction of the retardation film satisfy expression (A).

R0≦(⅝)×Rth−25 (A)

(15) A retardation film, wherein an in-plane retardation value R0 of in-plane direction and a thickness retardation value Rth of thickness direction satisfy expression (A).

R0≦(⅝)×Rth−25 (A)

(16) The retardation film according to the above-described (15), wherein the retardation film is used together with a liquid crystal layer.

(17) An electronic apparatus including

a display device, and

a control section configured to control operation carried out by utilizing the display device, wherein

the display device includes
a liquid crystal layer,
a first substrate including a first polarization film and a first retardation film, and
a second substrate that includes a second polarization film and is disposed on a side on which the first retardation film, of the first polarization film and the first retardation film, is disposed, of the first substrate, with intermediary of the liquid crystal layer, and

an in-plane retardation value R0 of in-plane direction of the first retardation film and a thickness retardation value Rth of thickness direction of the first retardation film satisfy expression (A).

R0≦(⅝)×Rth−25 (A)

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device comprising:
a liquid crystal layer;
a first substrate configured to include a first polarization film and a first retardation film; and
a second substrate configured to include a second polarization film and be disposed on a side on which the first retardation film, of the first polarization film and the first retardation film, is disposed, of the first substrate, with intermediary of the liquid crystal layer,
wherein an in-plane retardation value R0 of in-plane direction of the first retardation film and a thickness retardation value Rth of thickness direction of the first retardation film satisfy expression (A):
R0≦(⅝)×Rth−25 (A)

2. The display device according to claim 1, wherein the first retardation film is configured by triacetylcellulose or a cycloolefin polymer.

3. The display device according to claim 1, wherein the first retardation film has a reverse wavelength dispersion characteristic.

4. The display device according to claim 1, wherein the second substrate includes a second retardation film disposed on a side of the liquid crystal layer, of the second polarization film.

5. The display device according to claim 4, wherein an in-plane retardation value and a thickness retardation value of the second retardation film are substantially equal to the in-plane retardation value R0 and the thickness retardation value Rth, respectively, of the first retardation film.

6. The display device according to claim 4, wherein
the first retardation film is disposed on an opposite side to the liquid crystal layer, of the first substrate, and
the second retardation film is disposed on an opposite side to the liquid crystal layer, of the second substrate.

7. The display device according to claim 1, wherein the liquid crystal layer is configured by a twisted nematic liquid crystal that carries out normally-white operation.

8. A display device comprising:
a display section; and
a barrier section configured to have a liquid crystal barrier capable of being switched between an opened state and a closed state, wherein
the barrier section includes
a liquid crystal layer,
a first substrate including a polarization film and a retardation film, and
a second substrate disposed on a side on which the retardation film, of the polarization film and the retardation film, is disposed, of the first substrate, with intermediary of the liquid crystal layer, and
an in-plane retardation value R0 of in-plane direction of the retardation film and a thickness retardation value Rth of thickness direction of the retardation film satisfy expression (A):
R0≦(⅝)×Rth−25 (A)

9. The display device according to claim 8, wherein the barrier section has a plurality of first-series liquid crystal barriers and a plurality of second-series liquid crystal barriers.

10. The display device according to claim 9, wherein
the display device has a plurality of display modes including a two-dimensional image display mode and a three-dimensional image display mode,
in the two-dimensional image display mode, the display section displays one viewpoint image and a two-dimensional image is displayed by setting the plurality of first-series liquid crystal barriers and the plurality of second-series liquid crystal barriers to a transmissive state, and
in the three-dimensional image display mode, the display section displays a plurality of viewpoint images and a three-dimensional image is displayed by setting the plurality of first-series liquid crystal barriers to a transmissive state and setting the plurality of second-series liquid crystal barriers to a blocking state.

11. The display device according to claim 10, wherein
the plurality of first-series liquid crystal barriers are divided into a plurality of barrier groups, and
in the three-dimensional image display mode, the plurality of first-series liquid crystal barriers are switched between an opened state and a closed state in a time-division manner on each barrier group basis.

12. The display device according to claim 8, further comprising
a backlight, wherein
the display section is a liquid crystal display section, and
the liquid crystal display section is disposed between the backlight and the barrier section.

13. The display device according to claim 8, further comprising
a backlight, wherein
the display section is a liquid crystal display section, and
the barrier section is disposed between the backlight and the liquid crystal display section.

14. A barrier device comprising
a barrier section configured to have a liquid crystal barrier capable of being switched between an opened state and a closed state, wherein
the barrier section includes
a liquid crystal layer,
a first substrate including a polarization film and a retardation film, and
a second substrate disposed on a side on which the retardation film, of the polarization film and the retardation film, is disposed, of the first substrate, with intermediary of the liquid crystal layer, and
an in-plane retardation value R0 of in-plane direction of the retardation film and a thickness retardation value Rth of thickness direction of the retardation film satisfy expression (A):
R0≦(⅝)×Rth−25 (A)

15. A retardation film, wherein an in-plane retardation value R0 of in-plane direction and a thickness retardation value Rth of thickness direction satisfy expression (A):
R0≦(⅝)×Rth−2 (A)

16. The retardation film according to claim 15, wherein the retardation film is used together with a liquid crystal layer.

17. An electronic apparatus comprising:
a display device; and
a control section configured to control operation carried out by utilizing the display device, wherein
the display device includes
a liquid crystal layer,
a first substrate including a first polarization film and a first retardation film, and
a second substrate that includes a second polarization film and is disposed on a side on which the first retardation film, of the first polarization film and the first retardation film, is disposed, of the first substrate, with intermediary of the liquid crystal layer, and
an in-plane retardation value R0 of in-plane direction of the first retardation film and a thickness retardation value Rth of thickness direction of the first retardation film satisfy expression (A):
R0≦(⅝)×Rth−25 (A)
